(19) United States
(12) Patent Application Publication
(10) Pub. No.: US 2002/0033643 A1
(43) Pub. Date: Mar. 21, 2002

(54) Endless track for a vehicle

(76) Inventors: Gilles Soucy, Drummondville (CA); Yves St-Pierre, Wickham (CA); Andre Deland, Drummondville (CA); Claude Faucher, Drummondville (CA)

Correspondence Address: Robert Brouillette, BROUILLETTE KOSIE, 25th Floor, 1100 Rene-Levesque Boulevard West, Montreal, QC, H3B 5C9, CA

(21) Appl. No.: 09/954,168

(22) Filed: Sep. 18, 2001

(30) Foreign Application Priority Data
Sep. 18, 2000 (CA) 2,319,937

(51) Int. Cl. B62D 55/24

(52) U.S. Cl. 305/178

(57) ABSTRACT

The endless track is made of a reinforced rubber material with longitudinally spaced and transversely disposed ridges or lugs. It is particularly well-adapted for recreational snowmobiles having a single track. The ground-engaging side of the track features a tread pattern that is repeated uniformly or not over the entire length of the track. The tread pattern comprises a plurality of projecting traction lugs each an upper edge having which together delimit the general outline of a cross-sectional transversal traction lug profile when viewed along a longitudinal direction. The track is characterized in that the traction lug profile comprises a substantially flat central or interior section and two opposite exterior or lateral sections located on the sides of the interior section and that taper toward the exterior. Such track facilitates the steering capabilities of a snowmobile, particularly when the snowmobile is travelling on hard and abrasive surfaces. It also improves the durability of the track.

### BACKGROUND

The present invention relates to an endless track for a vehicle. More particularly, the present invention relates to a track which is particularly well suited for a vehicle having a single track, such as a conventional recreational snowmobile.

A track is found on off-road vehicles which are designed to travel on grounds that could not adequately support wheels or on which traction forces could not be suitably applied with the use of wheels. A track consists essentially of an endless band of a reinforced molded rubber material or an assembly of interconnected parts that form an endless band. The endless band is flexible around a transversal axis so that it can follow the curvature around drive and idler sprocket wheels. Each track is designed to support a portion of the weight of the vehicle and apply a traction force on the ground.

Among all off-road vehicles equipped with tracks, recreational snowmobiles are unique in that they are equipped with only one track while essentially all other vehicles are equipped with two or more tracks. Examples of such other vehicles are bulldozers, military tanks, snow-surfacing machines, etc. Tracks for vehicles with a single track, which are essentially snowmobiles, are the prime interest of the present invention.

A snowmobile is often equipped with a rubber-band track that features an endless body made of a reinforced rubber material with longitudinally spaced and transversely disposed stiffeners embedded in the rubber material. The body defines a longitudinally extending central portion and a pair of lateral band portions each of which is located on one of the sides of the central portion. The track is positioned under the chassis of the snowmobile and supports most of the weight. A pair of front ski-like runners are provided to steer the snowmobile and support the other portion of the weight.

The body of the track has a ground-engaging outer side and an inner side. The inner side cooperates with a suspension system. The weight of the track by either a pair of slide rails or a plurality of bogey wheels that are mechanically connected to the other parts of the suspension system. The suspension system is also used to support the track with respect to lateral movements.

The ground-engaging outer side has a tread pattern that is repeated uniformly or not over the entire length of the track. The tread pattern comprises a plurality of projecting traction lugs that are configured and disposed in accordance with the purpose for which the track is designed. The traction lugs are used to increase the adherence of the snowmobile on snow mud, melting snow, ice or any other similar surfaces.

Further, the opposite lateral band portions are separated from the central portion by a corresponding row of holes. Each row of holes generally cooperates with the teeth of a corresponding pair of drive and idler sprocket wheels. Alternatively, the drive and idler sprocket wheels may engage driving lugs that are inwardly projecting from the inner side of the track.

The outlines of the upper edge of adjacent traction lugs form what is referred to as a “traction lug profile” when they are viewed along the longitudinal axis of the track. The traction lug profile could be defined as the closest imaginary transversal line to the track under which all traction lugs can fit without touching it. The traction lug profile is clearly visible on a track by looking at the rear of a snowmobile or by looking at a transversal cross-sectional view of the track.

Formerly, the traction lug profile of a typical track had a shape which is somewhat flat in average. This means that the traction lugs on the sides of the track have about the same height than the traction lugs at the center thereof. This leads to a number of drawbacks. One of them is that a snowmobile is not easy to turn on hard surfaces, especially hard surfaces with which the track has an important friction level. When turning the snowmobile on such surfaces, the traction lugs of the sides of the track are subjected to an intense abrasion and to substantial stress concentrations due to the bending. Yet, the higher the traction lugs are, the greater is the tendency of a snowmobile to go straight ahead when torque is applied to the track. This phenomenon is particularly apparent on tracks which have high traction lugs for improving the traction on powdery or otherwise light snow-covered surfaces. Another drawback is that the outermost portions of the traction lugs near to sides of the track are subjected to premature wear. Moreover, this creates unpleasant driving situations to the driver.

The general steering capabilities of a snowmobile may be improved when the driver offsets his/her weight on the side of the snowmobile. This forces the track to bend and it shifts the position of the center of rotation to a more appropriate location. However, considering the weight of some snowmobiles on the market and the fact that some drivers are not heavy enough or are not interested in or capable of performing such movements, there is a need for an improved track which is facilitates the general steering capabilities of a snowmobile. There is a similar need for a track which reduces the risks of having a premature wear of the traction lugs located on the sides of the track.

### SUMMARY

One aspect of the present invention is to facilitate the steering capabilities of a snowmobile, particularly when the snowmobile is traveling on a hard surface, by reducing the interferences from the traction lug located on the sides of the track while still having a tread pattern which can have highly projecting traction lugs in the center thereof. It has been found that providing a traction lug profile with two tapered ends leads to a track with a rotation point that facilitates the steering of the snowmobile and improves its durability.

These and other aspects and advantages of the present invention are described in or apparent from the following detailed description of a preferred embodiment made in conjunction which the apparent figures.

### BRIEF DESCRIPTION OF THE FIGURES

FIG. 1 is a plan view of an example of a track according to a preferred embodiment of the present invention.

FIG. 2 is a transversal cross-sectional view taken from line A-A in FIG. 1.

### DETAILED DESCRIPTION

A track (10) according to a possible and preferred embodiment of the present invention is described hereinafter and illustrated in the appended figures.

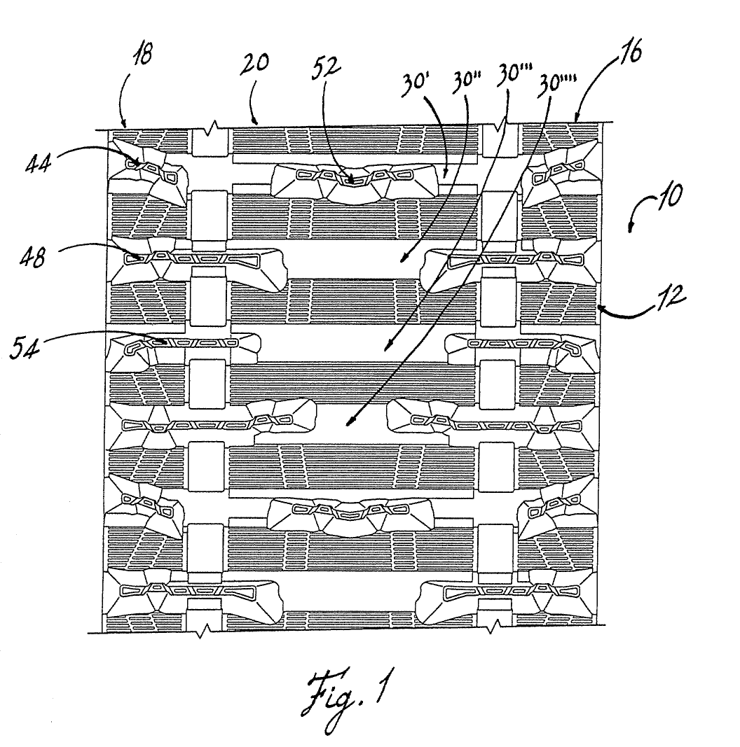

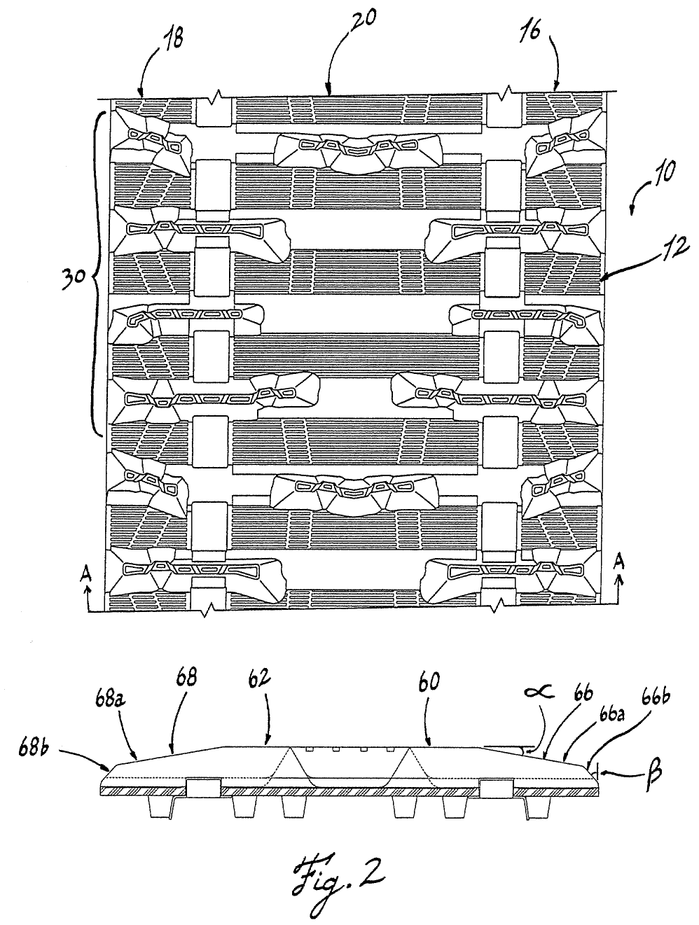

As shown in FIGS. 1 and 2, the track comprises an endless body (12) made of a reinforced rubber material with longitudinally spaced and transversely disposed stiffeners (not shown) may or may not be embedded in the rubber material. The body defines a longitudinally extending central portion (20) and a pair of opposite lateral band portions (16,18) each of which is located on one side of the central portion (20).

The body (12) of the track (10) has a ground-engaging outer side that is provided with a tread pattern (30). The tread pattern (30) is repeated uniformly or not over the entire length of the track (10). The tread pattern (30) comprises a plurality of projecting traction lugs (42,44,45,46,48) disposed on the central band portion (20), on the lateral band portions (16,18) or both. The traction lugs typically have between ¾ and 3 inches in lateral length. The width of the central band portion (20) is typically in the range of 5 to 10 inches, with a preferred value of 6½ inches when the total width of the track (10) is 15 inches.

Each of the traction lugs (42,44,45,46,48) has an upper edge that together delimit the general outline of a cross-sectional transversal traction lug profile (60) when viewed along the longitudinal axis of the track. The expression “general outline” refers to the average laterally extending line formed by the upper edges of the lugs, which are often provided with small regular or jagged indentations. This traction lug profile (60) is shown in FIG. 2. Now, in accordance with the present invention, the track (10) is characterized in that the traction lug profile (60) comprises a substantially flat interior or central section (62) and two opposite exterior or lateral sections (66,68) each, located on one side of the interior section (62) and which tapers toward the exterior. The exterior sections (66,68) are preferably straight and symmetrical with reference to a medial axis of the interior section (62). Alternatively, the interior sections (66,68) are curved and symmetrical with reference to the medial axis of the interior section (62).

Preferably, the exterior sections (66,68) have an average angle ∝ in the range of 10 to 40 degrees with reference to the interior section (62). Further, the interior section (62) has a width that is somewhat equal to that of the central band portion (20) and the exterior sections (66,68) have a width that is somewhat equal to that of the corresponding lateral band portion (16,18).

Preferably, each of the exterior sections (66,68) comprises an innermost main subsection (66a,68a) having an average angle ∝ in the range of 10 to 40 degrees with reference to the outline of the interior section (62), and an outermost tip subsection (66b,68b) having an average angle β in the range of 40 to 80 degrees with reference to the outline of the interior section (62).

It should be noted that when designing a track (10) in accordance with the present invention, it is important to have a sufficient angular demarcation between the interior section (62) and the exterior sections (66,68) so as to create a rotation point that does not make the track (10) unstable when traveling in a straight course. Thus, the interior section (62) has to be large enough to adequately support the snowmobile.

Although a preferred embodiment of the invention has been described in detail herein and illustrated in the accompanying figures, it is to be understood that the invention is not limited to this precise embodiment and that various changes and modifications may be effected therein without departing from the scope or spirit of the present invention.

What is claimed is:

1. An endless track for a vehicle, the track having an endless body made of a reinforced rubber material, the body defining a longitudinally extending central portion and two lateral band portions each of which is located on one side of the central portion, the body having a ground-engaging outer side and an inner side, the ground-engaging outer side having a tread pattern being repeated uniformly or not over the entire length of the track, the tread pattern comprising a plurality of projecting traction lugs each having an upper edge which together delimit the outline of a cross-sectional transversal traction lug profile when viewed along a longitudinal direction, the track being characterized in that the traction lug profile comprises:
a substantially flat central section; and
two opposite lateral sections each located on one side of the central section and tapered towards the exterior.

2. An endless track according to claim 1, characterized in that the lateral sections of the traction lug profile have an average angle in the range of 10 to 40 degrees with reference to the central section.

3. An endless track according to claim 1, characterized in that each lateral section of the traction lug profile comprises:
an innermost main subsection having an average angle in the range of 10 to 40 degrees with reference to the cental section; and
an outermost tip subsection having an average angle in the range of 40 to 80 degrees with reference to the central section.

4. An endless track according to claim 1, characterized in that the central section of each traction lug profile is straight and is generally parallel to the other traction lug profiles and to the central portion of the body when viewed along its longitudinal axis.

5. An endless track according to claim 1, characterized in that the central section of the traction lug profile is curved and symmetrical with reference to the longitudinal axis of the track.

6. An endless track according to claim 1, characterized in that the central section of the traction lug profile has a width that is somewhat equal to that of the central portion, each lateral section of the traction lug profile has a width that is somewhat equal to that of the corresponding lateral band portion.

7. An endless track according to claim 1, characterized in that the vehicle is a snowmobile.

8. An endless track according to claim 2, characterized in that the vehicle is a snowmobile.

9. An endless track according to claim 3, characterized in that the vehicle is a snowmobile.

10. An endless track according to claim 4, characterized in that the vehicle is a snowmobile.

11. An endless track according to claim 5, characterized in that the vehicle is a snowmobile.

12. An endless track according to claim 6, characterized in that the vehicle is a snowmobile.

13. An endless track according to claim 7, characterized in that the vehicle is a snowmobile.
